(19) United States
(12) Patent Application Publication
(10) Pub. No.: US 2017/0107787 A1
(43) Pub. Date: Apr. 20, 2017

(54) MICROWAVE INDUCED CURING OF NANOMATERIALS FOR GEOLOGICAL FORMATION REINFORCEMENT

(71) Applicants: James M. Tour, Bellaire, TX (US); Nam Dong Kim, Houston, TX (US); Andrew Metzger, Houston, TX (US); Anton Kovalchuk, Katy, TX (US); Brandi Katherine Price-Hoelscher, Houston, TX (US); James E. Friedheim, Spring, TX (US)

(72) Inventors: James M. Tour, Bellaire, TX (US); Nam Dong Kim, Houston, TX (US); Andrew Metzger, Houston, TX (US); Anton Kovalchuk, Katy, TX (US); Brandi Katherine Price-Hoelscher, Houston, TX (US); James E. Friedheim, Spring, TX (US)

(73) Assignees: William Marsh Rice University, Houston, TX (US); M-I, L.L.C., Houston, TX (US)

(21) Appl. No.: 15/295,509

(22) Filed: Oct. 17, 2016

Related U.S. Application Data
(60) Provisional application No. 62/241,934, filed on Oct. 15, 2015.
(60) Provisional application No. 62/286,210, filed on Jan. 22, 2016.

(51) Int. Cl. E21B 33/138; C08J 3/28; C09K 8/035; C08K 3/04; C08F 279/02; C08K 9/08; C08J 5/00; C08J 3/24

(52) U.S. Cl. CPC E21B 33/138; C08J 5/005; C08J 3/28; C08J 3/247; C08K 3/04; C08F 279/02; C08K 9/08; C09K 8/035; C08J 2347/00; C09K 2208/10

(57) ABSTRACT

Embodiments of the present disclosure pertain to methods of forming a polymer composite by exposing a solution that includes nanomaterials (e.g., functionalized graphene nanoribbons) and cross-linkable polymer components (e.g., thermoset polymers and monomers) to a microwave source, where the exposing results in the curing of the cross-linkable polymer component in the presence of the nanomaterial to form the polymer composite. The solution may be exposed to a microwave source in a geological formation such that the formed polymer composite becomes embedded with the geological formation and thereby enhances the stability of the geological formation. Additional embodiments of the present disclosure pertain to the aforementioned polymer composites.

### CROSS-REFERENCE TO RELATED APPLICATIONS

This application claims priority to U.S. Provisional Patent Application No. 62/241,934, filed on Oct. 15, 2015; and U.S. Provisional Patent Application No. 62/286,210, filed on Jan. 22, 2016. The entirety of each of the aforementioned applications is incorporated herein by reference.

### STATEMENT REGARDING FEDERALLY SPONSORED RESEARCH

Not applicable.

### BACKGROUND

Current methods and materials for maintaining and enhancing the stability of geological formations have numerous limitations, including insufficient stability enhancement, and potential toxicity. The present disclosure addresses such limitations.

### SUMMARY

In some embodiments, the present disclosure pertains to methods of forming a polymer composite. In some embodiments, the methods of the present disclosure include a step of exposing a solution that includes a nanomaterial (e.g., functionalized graphene nanoribbons) and a cross-linkable polymer component (e.g., thermoset polymers and monomers) to a microwave source. In some embodiments, the exposing results in the curing of the cross-linkable polymer component in the presence of the nanomaterial to form the polymer composite.

in some embodiments, the solution also includes an additive, such as drilling fluids, oils, mineral oils, oil based muds, water-in-oil emulsions, water-based muds, viscosifiers, surfactants, nanoclays, weighting agents, and combinations thereof. In some embodiments, the solution also includes a cross-linking agent.

In some embodiments, the methods of the present disclosure also include steps of introducing the solution into a geological formation, and exposing the solution to a microwave source in the geological formation in order to form a polymer composite embedded with the geological formation. In some embodiments, the formed polymer composite enhances the stability of the geological formation by enhancing the mechanical properties of the geological formation (e.g., compressive strength, toughness, hardness, elastic modulus, and combinations thereof). In some embodiments, the geological formation includes, without limitation, subterranean formations, wellbores, boreholes, sandstones, shale formations, carbonates, mudstones, oil fields, and combinations thereof.

In some embodiments, the methods of the present disclosure include a step of introducing into a geological formation a fluid and irradiating the geological formation with microwaves. In some embodiments, the fluid includes a base fluid and graphene nanoribbons.

Additional embodiments of the present disclosure pertain to the aforementioned polymer composites. In some embodiments, the polymer composites of the present disclosure include a network of polymers and nanomaterials associated with the network of polymers.

### DESCRIPTION OF THE FIGURES

FIG. 1 provides schemes of methods of forming polymer composites (FIG. 1A) and enhancing the stability of geological formations (FIG. 1B).

FIG. 2 provides a comparison of the dispersibility of graphene nanoribbons (GNRs) and polypropylene oxide (PPO)-functionalized GNRs (PPO-GNRs) in various media, including GNRs in water (FIG. 2A, vial 1), GNRs in Escaid™ (FIG. 2B, vial 2), PPO-GNRs in water (FIG. 2C, vial 3), and PPO-GNRs in Escaid™ ((FIG. 2D, vial 4). The vials were shaken and permitted to settle for 1 day before photographing.

FIG. 3 illustrates the synthesis and characterization of PPO-GNRs. FIG. 3A provides a scheme for the synthesis of PPO-GNRs from multi-walled carbon nanotubes (MWNTs). Only one tube within the MWNT is represented. Also shown are the characterization of GNRs and PPO-GNRs by thermogravimetric analysis (TGA) (FIG. 3B), Fourier transform infrared (FT-IR) analysis (FIG. 3C), and Raman Spectroscopy (FIG. 3D).

FIG. 4 provides various structures and data relating to polymer solutions. FIG. 4A provides chemical structures of a polymer (1,2-polybutadiene (1,2-PBD)) and a crosslinker (ethylene glycol dimethacrylate (EGDMA)). FIG. 4B shows images of a thermoset polymer stock solution before and after curing in an oven at 200° C. FIG. 4C shows a differential scanning calorimetry (DSC) characterization of the polymer solution.

FIG. 5 shows pictures of thermally cured mixtures of 1,2-PBD with different (meth)acrylates (i.e., FIGS. 5A-D). Applicants confirmed that di(meth)acrylates could successfully cure 1,2-PBD, thereby producing a solidified monolith, while mono(meth)acrylates did not polymerize into solid products.

FIG. 6 shows data and illustrations relating to the microwave-assisted curing of polymer/PPO-GNR suspensions. FIG. 6A provides an illustration of the microwave-assisted polymer curing system using a waveguide and an in situ temperature monitor with a photograph of the polymer/PPO-GNRs suspension before and after microwave curing. FIG. 6B shows the microwave heating profile of GNR, 20%-PPO-GNR, and 40%-PPO-GNR suspensions. FIG. 6C shows the microwave heating profile of the polymer/PPO-GNR suspension containing different amounts of 20%-PPO-GNR.

FIG. 7 illustrates the fabrication of microwave-cured polymer/PPO-GNR infiltrated sandstone (SPG-M). FIG. 7A shows an experimental scheme for the preparation of SPG-M. FIG. 7B shows a photograph of the cross-section of SPG-M. The black squares, 1 and 2, correspond to scanning electron microscopy (SEM) images in FIG. 7C and FIG. 7D, respectively. FIG. 7E shows an SEM image of the inside of SPG-M and corresponding energy dispersive X-rays (EDX) elemental mapping of Si, O, and C.

FIG. 8 shows compression mechanical tests of sandstone alone and polymer/PPO-GNRs infiltrated sandstones cured either by convective oven or microwaves. Shown are a stress vs strain plot (FIG. 8A), maximum compressive strength (FIG. 8B), and toughness (FIG. 8C). Note: SP=sandstone infiltrated with polymer alone, SPG=sandstone infiltrated with polymer/PPO-GNRs, O=oven cured, and M=microwave cured.

FIG. 9 shows images of an SPG-M sample before (left panel) and after (right panel) compression mechanical testing.

FIG. 10 shows a nanoindentation test for the effect of microwave-assisted cured polymer on mechanical enhancement. FIG. 10A shows an optical image of the SPG-M sample before indentation experiments. Enlarged images before (FIG. 10B) and after (FIG. 10C) indentation are also shown. A part of the 10×10 matrix of indentation imprints (triangles) can be seen in FIG. 10C. FIG. 10D shows hardness values from nanoindentation experiments for polymer alone, SPG-O, and SPG-M. The inset shows differences of hardness between polymer and sandstone. FIG. 10E shows an elastic modulus value from the nanoindentation experiments for polymer, SPG-O, and SPG-M.

FIG. 11 shows a schematic illustration of a microwave curing system equipped with a waveguide and in situ temperature monitor. Shown are a microwave power generator with transmitted and reflected power meters (1); a coaxial cable antenna (E-field directed horizontally to eliminate thermocouple heating) (2); a waveguide (intensity of microwave is highest in the middle of the waveguide) (3); a thermocouple with PTFE insulator (shielded and ungrounded) (4); a cuvette with polymer/PPO-GNR suspension (5); a glass vessel filled with water to absorb transmitted microwaves (minimize reflection at the end of the waveguide) (6); and a microwave oven chassis that functions as a shield (enclosed power supply is disabled) (7).

FIG. 12 shows a representative trapezoidal loading and force versus time plot of a nanoindentation experiment.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The structural integrity of geological formations (e.g., wellbores) is important during oilfield drilling. For instance, lost circulation and wellbore collapse caused by drilling through unstable geological formations can result in expensive losses of time, drilling fluids, and desirable oil.

Several strategies have been utilized to maintain and enhance the stability of geological formations. For instance, various methods have focused on stabilizing existing and induced cracks by adjusting geological formation (e.g., borehole) pressure; controlling the swelling and dehydration of geological formation components (e.g., shale); changing stress around a geological formation (e.g., borehole) by adjusting temperature or pressure; reducing geological formation (e.g., borehole) size and irregularities; installing equipment to support the geological formation (e.g., borehole), such as conventional and expandable casing; chemically consolidating the geological formation; and changing geological formation (e.g., oil well) trajectories.

Furthermore, wellbore reinforcement in oil and gas recovery has received considerable attention over the last two decades because wellbore instability can lead to substantially higher drilling costs. Microfractures present in the rock formation are a common cause of severe wellbore instability because drilling fluid seeps into these fractures, thereby inhibiting the stabilizing effect of the drilling fluid overbalance and reducing borehole pressure integrity by forcing fractures even further apart. Therefore, there has been a substantial effort to stabilize wellbores and prevent fluid loss by using additives such as mica, calcium carbonate, gilsonite and asphalt.

However, the aforementioned attempts to maintain and enhance the stability of geological formations have not been widely implemented because of various limitations. For instance, the size of conventional additives do not match the size of porous geological formations. Furthermore, many conventional methods are too slow in sealing microfractures within geological formations. Accordingly, a need exists for the development of deformable additives with a broad size distribution capable of quickly sealing a wide-range of microfracture openings at an effective concentration that does not adversely affect the functional properties of the drilling fluid.

Nanomaterials have contributed to numerous of the aforementioned strategies. For instance, nanomaterials have been utilized to fill cracks within geological formations, and to consolidate the geological formations. Such approaches have enhanced the mechanical properties of the geological formations. Furthermore, additives containing nanomaterials have been utilized to aid the microwave heating of crosslinkable components in a drilling mud in order to increase the stability of a wellbore, thereby decreasing the risks and costs associated with drilling.

In particular, carbon nanotubes have been explored as polymeric reinforcements due to their small size, high Young's modulus, high tensile strength, and low percolation threshold. Another advantageous property of carbon nanotubes is that they are highly efficient microwave absorbers.

Although the precise mechanism of carbon nanotube-microwave interaction is not fully understood, carbon nanotubes generate intense heat that could be used in thermoset polymers for rapid curing at much lower microwave powers than those currently used in microwave assisted polymer curing (˜900 W). However, concerns over their toxicity as well as problems in preparing homogeneous carbon nanotube dispersion have impeded their commercial deployment.

As such, more improved methods and materials are required for enhancing the stability of geological formations. Various embodiments of the present disclosure address the aforementioned limitations.

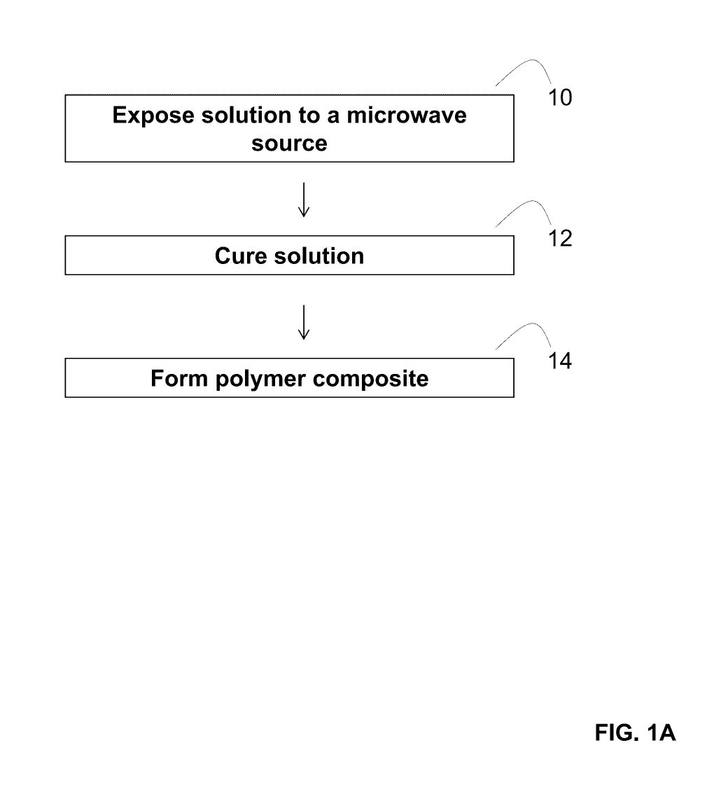

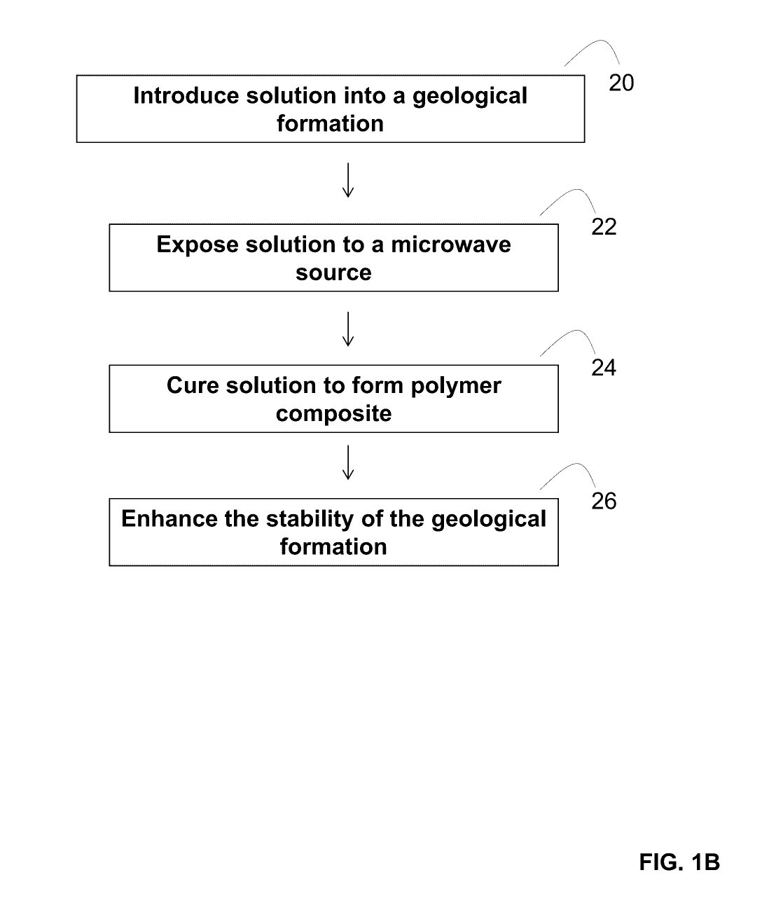

In some embodiments, the present disclosure pertains to methods of forming a polymer composite. In some embodiments illustrated in FIG. 1A, the methods of the present disclosure include a step of exposing a solution that contains a nanomaterial and a cross-linkable polymer component to a microwave source (step 10). In some embodiments, the exposing results in the curing (step 12) of the cross-linkable polymer component in the presence of the nanomaterial to form the polymer composite (step 14). Additional embodiments of the present disclosure pertain to the formed polymer composites.

In some embodiments, the methods of the present disclosure occur within a geological formation. In such embodiments, the methods of the present disclosure can be utilized to enhance the stability of the geological formation. In some embodiments illustrated in FIG. 1B, such methods involve a step of introducing a solution of the present disclosure into a geological formation (step 20), and exposing the solution to a microwave source (step 22) to result in the curing of the solution and the formation of a polymer composite within the geological formation (step 24). As such, the formed polymer composite enhances the stability of the geological formation (step 26).

In some embodiments, the methods of the present disclosure include a step of introducing into a geological formation a fluid and irradiating the geological formation with microwaves. In some embodiments, the fluid includes a base fluid and graphene nanoribbons.

As set forth in more detail herein, various types of nanomaterials and cross-linkable polymer components in a solution may be exposed to various types of microwave sources to result in the formation of various types of polymer composites. Moreover, the methods of the present disclosure can occur in various types of geological formations. In addition, the methods of the present disclosure can enhance the stability of geological formations in various manners.

Solutions

In some embodiments, the solutions of the present disclosure include a nanomaterial and a cross-linkable polymer component. The solutions of the present disclosure can also include additional materials.

For instance, in some embodiments, the solutions of the present disclosure also include an additive. In some embodiments, the additive includes, without limitation, drilling fluids, oils, mineral oils, oil based muds, water-in-oil emulsions, water-based muds, viscosifiers, surfactants, nanoclays, weighting agents, and combinations thereof. In some embodiments, the additive includes a drilling fluid, such as Escaid 110. In some embodiments, the additive includes, without limitation, viscosifiers, surfactants, clays, weighting agents, and combinations thereof.

In some embodiments, the solution includes a fluid, such as a base fluid. In some embodiments, the base fluid includes, without limitation, oleaginous fluids, non-oleaginous fluids, and combinations thereof.

In some embodiments, the solution includes an oleaginous fluid. In some embodiments, the oleaginous fluid includes, without limitation, natural oils, synthetic oils, diesel oils, mineral oils, invert emulsions thereof, and combinations thereof.

In some embodiments, the solution includes a non-oleaginous fluid. In some embodiments, the non-oleaginous fluid includes, without limitation, water, sea water, brine, and combinations thereof.

In some embodiments, the solutions of the present disclosure also include a cross-linking agent. In some embodiments, the cross-linking agent includes, without limitation, free radical initiators, sulfur-based cross-linking agents, isocyanate-based cross-linking agents, isocyanurate-based cross-linking agents, maleimide-based cross-linking agents, ester-based cross-linking agents, carbodiimide-based cross-linking agents, azide-based cross-linking agents, and combinations thereof. In some embodiments, the cross-linking agent includes ester-based cross-linking agents, such as ethylene glycol dimethacrylate (EGDMA). In some embodiments, the cross-linking agent includes isocyanurate-based cross-linking agents, such as triallyl isocyanurate.

Nanomaterials

The solutions of the present disclosure can also include various nanomaterials. For instance, in some embodiments, the nanomaterials of the present disclosure include hydrophilic nanomaterials. In some embodiments, the nanomaterials of the present disclosure include amphiphilic nanomaterials. In some embodiments, the nanomaterials of the present disclosure include, without limitation, carbon nanomaterials, graphite, single-walled carbon nanotubes, multi-walled carbon nanotubes, ultra-short carbon nanotubes, graphene, graphene oxide, graphene nanoribbons, carbon black, glassy carbon, carbon nanofoam, silicon carbide, buckminsterfullerene, buckypaper, nanofiber, nanoplatelets, nano-onions, nanoribbons, nanohorns, nano-hybrids, carbon fibers, metal nanoparticles, iron nanoparticles, derivatives thereof, and combinations thereof.

In some embodiments, the nanomaterials of the present disclosure include graphite, such as expanded graphites (e.g., chemically or commercially expanded graphites). In some embodiments the nanomaterials of the present disclosure exclude carbon nanotubes.

The nanomaterials of the present disclosure may be functionalized with one or more functional groups. In some embodiments, the functional groups include oil-soluble functional groups. In some embodiments, the functional groups include, without limitation, alkyl groups, alkyl halides, hydroxyl alkyl groups, amino alkyl groups, haloalkyl groups, alkenyl groups, alkynyl groups, sulfate groups, sulfonate groups, carboxyl groups, benzenesulfonate groups, amines, alkyl amines, nitriles, quaternary amines, thermoplastic polymers, and combinations thereof.

In some embodiments, the nanomaterials of the present disclosure include graphene nanoribbons. Graphene nanoribbons generally refer to ribbon-like graphene. In some embodiments, graphene nanoribbons are preferred nanomaterials due to their low percolation threshold, high load transfer capability, and low toxicity.

Various graphene nanoribbons may be utilized as nanomaterials. For instance, in some embodiments, the graphene nanoribbons include, without limitation, functionalized graphene nanoribbons, pristine graphene nanoribbons, doped graphene nanoribbons, mixtures of graphene nanoribbons and carbon nanotubes, graphene oxide nanoribbons, reduced graphene oxide nanoribbons, and combinations thereof.

In some embodiments, the nanomaterials of the present disclosure include functionalized graphene nanoribbons. In some embodiments, the functionalized graphene nanoribbons are functionalized with one or more thermoplastic polymers. In some embodiments, the nanomaterials of the present disclosure include polypropylene oxide-functionalized graphene nanoribbons.

The graphene nanoribbons of the present disclosure can include various layers. For instance, in some embodiments, the graphene nanoribbons of the present disclosure include a single layer. In some embodiments, the graphene nanoribbons of the present disclosure include a plurality of layers. In some embodiments, the graphene nanoribbons of the present disclosure include from about 2 layers to about 60 layers. In some embodiments, the graphene nanoribbons of the present disclosure include from about 2 layers to about 10 layers.

The graphene nanoribbons of the present disclosure can also have various widths. For instance, in some embodiments, the graphene nanoribbons of the present disclosure include widths ranging from about 75 nm to about 750 nm. In some embodiments, the graphene nanoribbons of the present disclosure include widths of less than about 500 nm. In some embodiments, the graphene nanoribbons of the present disclosure include widths of less than about 350 nm. In some embodiments, the graphene nanoribbons of the present disclosure include widths of less than about 250 nm. In some embodiments, the graphene nanoribbons of the present disclosure include widths of more than about 250 nm. In some embodiments, the graphene nanoribbons of the present disclosure include widths ranging from about 250 nm to about 350 nm. In some embodiments, the graphene nanoribbons of the present disclosure include widths ranging from about 250 nm to about 500 nm. In some embodiments, the graphene nanoribbons of the present disclosure include widths of about 350 nm. In some embodiments, the graphene nanoribbons of the present disclosure include widths of about 250 nm.

The graphene nanoribbons of the present disclosure can also have various lengths. For instance, in some embodiments, the graphene nanoribbons of the present disclosure include lengths ranging from about 10 μm to about 500 μm. In some embodiments, the graphene nanoribbons of the present disclosure include lengths ranging from about 10 μm to about 100 μm. In some embodiments, the graphene nanoribbons of the present disclosure include lengths ranging from about 10 μm to about 50 μm. In some embodiments, the graphene nanoribbons of the present disclosure include lengths ranging from about 30 μm to about 50 μm.

The graphene nanoribbons of the present disclosure can also have various length-to-width aspect ratios. For instance, in some embodiments, the graphene nanoribbons of the present disclosure include length-to-width aspect ratios that range from about 10 to about 5,000. In some embodiments, the graphene nanoribbons of the present disclosure include length-to-width aspect ratios that range from about 10 to about 150. In some embodiments, the graphene nanoribbons of the present disclosure include length-to-width aspect ratios that range from about 100 to about 150. In some embodiments, the graphene nanoribbons of the present disclosure include a length-to-width aspect ratio of about 140. In some embodiments, the graphene nanoribbons of the present disclosure include a length-to-width aspect ratio of more than about 140.

The graphene nanoribbons of the present disclosure may be derived from various carbon sources. For instance, in some embodiments, the graphene nanoribbons of the present disclosure may be derived from carbon nanotubes, such as multi-walled carbon nanotubes. In some embodiments, the graphene nanoribbons of the present disclosure are derived through the longitudinal splitting (or “unzipping”) of carbon nanotubes.

Various methods may be used to split (or “unzip”) carbon nanotubes to form graphene nanoribbons. In some embodiments, carbon nanotubes may be split by exposure to potassium, sodium, lithium, alloys thereof, metals thereof, salts thereof, and combinations thereof. For instance, in some embodiments, the splitting may occur by exposure of the carbon nanotubes to a mixture of sodium and potassium alloys, a mixture of potassium and naphthalene solutions, and combinations thereof. In some embodiments, the graphene nanoribbons of the present disclosure are made by the longitudinal splitting of carbon nanotubes using oxidizing agents (e.g., KMnO₄). In some embodiments, the graphene nanoribbons of the present disclosure are made by the longitudinal opening of carbon nanotubes (e.g., multi-walled carbon nanotubes) through in situ intercalation of Na/K alloys into the carbon nanotubes. In some embodiments, the intercalation may be followed by quenching with a functionalizing agent (e.g., 1-iodohexadecane) to result in the production of functionalized graphene nanoribbons (e.g., hexadecyl-functionalized graphene nanoribbons).

Additional variations of the aforementioned embodiments of forming graphene nanoribbons are described in U.S. Provisional Application No. 61/534,553 entitled “One Pot Synthesis of Functionalized Graphene Oxide and Polymer/Graphene Oxide Nanocomposites.” Also see PCT/US2012/055414, entitled “Solvent-Based Methods For Production Of Graphene Nanoribbons.” Also see Higginbotham et al., “Lower-Defect Graphene Oxide Nanoribbons from Multiwalled Carbon Nanotubes,” ACS Nano 2010, 4, 2059-2069. Also see Applicants' co-pending U.S. Pat. App. No. 12/544,057 entitled “Methods for Preparation of Graphene Oxides From Carbon Nanotubes and Compositions, Thin Composites and Devices Derived Therefrom.” Also see Kosynkin et al., “Highly Conductive Graphene Oxides by Longitudinal Splitting of Carbon Nanotubes Using Potassium Vapor,” ACS Nano 2011, 5, 968-974. Also see WO 2010/14786A1. Also see Genorio et al., “In Situ Intercalation Replacement and Selective Functionalization of Graphene Nanoribbon Stacks,”ACS Nano 2012, 6, 4231-4240 (DOI: 10.1021/nn300757t).

The solutions of the present disclosure can include various amounts of nanomaterials. For instance, in some embodiments, the nanomaterials include from about 0.1 wt % to about 50 wt % of the solution. In some embodiments, the nanomaterials include from about 0.1 wt % to about 20 wt % of the solution. In some embodiments, the nanomaterials include from about 0.1 wt % to about 10 wt % of the solution. In some embodiments, the nanomaterials include from about 0.1 wt % to about 5 wt % of the solution. In some embodiments, the nanomaterials include from about 0.1 wt % to about 1 wt % of the solution. In some embodiments, the nanomaterials include more than about 10 wt % of the solution. In some embodiments, the nanomaterials include more than about 15 wt % of the solution.

Cross-Linkable Polymer Components

The solutions of the present disclosure can also include various types of cross-linkable polymer components. For instance, in some embodiments, the cross-linkable polymer component includes, without limitation, polymers, monomers, and combinations thereof.

In some embodiments, the cross-linkable polymer component includes polymers. In some embodiments, the polymers include, without limitation, thermoset polymers, thermoplastic polymers, and combinations thereof. In some embodiments, the polymers include, without limitation, thermoset polymers, thermoplastic polymers, polyamines, polyetheramines, polyalcohols, polystyrene, polybutadiene, polyisocyanate, and combinations thereof. In some embodiments, the cross-linkable polymer component includes thermoset polymers, such as 1,2-polybutadiene (1,2-PBD).

In some embodiments, the cross-linkable polymer component includes thermoplastic polymers. In some embodiments, the thermoplastic polymers include, without limitation, polylactic acid, polybenzimidazole, polycarbonate, polyether sulfone, poly ether ether ketone, polyetherimide, polyethylene, polyphenylene oxide, polyphenylene sulfide, polypropylene, polystyrene, polyvinyl chloride, poly(methyl methacrylate), acrylonitrile butadiene styrene, nylon, polylactic acid, teflon, and combinations thereof. In some embodiments, the thermoplastic polymer includes polypropylene, such as polypropylene oxide (PPO).

In some embodiments, the cross-linkable polymer component includes monomers. In some embodiments, the monomers include, without limitation, epoxy resins, olefin monomers, amines, etheramines, alcohols, styrenes, butadienes, isocyanates, lactic acids, benzimidazoles, carbonates, ether sulfones, ether ketones, etherimides, ethylenes, phenylene oxides, phenylene sulfides, propylenes, styrenes, vinyl chlorides, methacrylates, acrylonitriles, and combinations thereof. In some embodiments, the monomers include ethylene glycol dimethacrylate.

In some embodiments, the cross-linkable polymer component includes monomers and polymers. In some embodiments, the polymers and monomers are present in a solution at different molar ratios. In some embodiments, the polymers and monomers are present in a solution at a molar ratio of about 1:10.

The cross-linkable polymer components of the present disclosure can have various properties. For instance, in some embodiments, the cross-linkable polymer components have relatively high curing temperature (e.g., curing temperatures of more than about 70° C.). In some embodiments, such high curing temperatures ensure that high temperature conditions in a geological formation do not prematurely result in curing. In some embodiments, the cross-linkable polymer components have low toxicity.

Exposure of Solutions to a Microwave Source

The solutions of the present disclosure may be exposed to various types of microwave sources at various power ranges. For instance, in some embodiments, the microwave source is a microwave system with a variable power control. In some embodiments, the microwave source includes, without limitation, high-power microwave sources, low-power microwave sources, and combinations thereof. In some embodiments, the microwave source includes a radio frequency (RF) source (i.e., a microwave source that emits RF waves). The use of additional microwave sources can also be envisioned.

The solutions of the present disclosure can be exposed to a microwave source through the use of various devices. For instance, in some embodiments, the solutions of the present disclosure are exposed to a microwave source through the use of open-wire transmission lines, coaxial transmission lines, waveguides, oscillators, and combinations thereof. In some embodiments, the solutions of the present disclosure are exposed to a microwave source through the use of a waveguide.

The microwave sources of the present disclosure can be operated at various power ranges. For instance, in some embodiments, the microwave source is operated at powers that range from about 1 W to about 2,000 W. In some embodiments, the microwave source is operated at powers that range from about 1 W to about 1,500 W. In some embodiments, the microwave source is operated at powers that range from about 1 W to about 500 W. In some embodiments, the microwave source is operated at powers that range from about 10 W to about 100 W. In some embodiments, the microwave source is operated at a power of about 30 W. In some embodiments, the microwave source is operated at powers of more than about 10 W. In some embodiments, the microwave source is operated at powers of more than about 100 W. Additional power ranges can also be envisioned.

Introduction of Solutions into Geological Formations

The solutions of the present disclosure may be exposed to a microwave source in various environments. For instance, in some embodiments, the solutions of the present disclosure may be exposed to a microwave source, such as that described in U.S. Pat. Pub. 2009/0260818 and U.S. Pat. No. 6,214,175, which are incorporated by reference in their entirety, in a geological formation. As such, in some embodiments, the methods of the present disclosure also include a step of introducing the solutions of the present disclosure into a geological formation, and irradiating the geological formation with microwaves.

The solutions of the present disclosure may be introduced into various geological formations. For instance, in some embodiments, the geological formation includes, without limitation, subterranean formations, wellbores, boreholes, sandstones, mudstones, carbonate formations, shale formations, oil fields, and combinations thereof. In some embodiments, the geological formation includes wellbores. In some embodiments, the geological formation includes sandstones.

In some embodiments, the solutions of the present disclosure may be exposed to a microwave source in the presence of a geological formation component. In some embodiments, the geological formation component includes a sandstone. In some embodiments, the geological formation component includes a shale. In some embodiments, the geological formation component includes carbonates.

The solutions of the present disclosure may be introduced into geological formations in various manners. For instance, in some embodiments, the solutions of the present disclosure may be introduced into a geological formation by pumping the solutions into the geological formation. In some embodiments, the pumping occurs by the utilization of a pump. In some embodiments, the pumping occurs under higher pressure than a wellhead pressure. In some embodiments, the pumping occurs through the action of a drill head.

In some embodiments, the solutions of the present disclosure may be introduced into a geological formation by physically pouring the solutions into the geological formation. Additional methods of introducing the solutions of the present disclosure into geological formations can also be envisioned.

Curing of Solutions

The exposure of the solutions of the present disclosure to a microwave source results in the curing of the solution and the formation of polymer composites. Curing can occur by various mechanisms. For instance, in some embodiments, the curing occurs by a microwave-triggered activation of crosslinkable polymer components. In some embodiments, the curing of the solution involves the heating of the solution. For instance, in some embodiments, the microwave source heats the nanomaterials. Thereafter, the heat from the nanomaterials induces the polymerization of the cross-linkable polymer components in the solution. In some embodiments, the solution is heated to temperatures above 100° C. In some embodiments, the solution is heated to temperatures of about 200° C.

In some embodiments, curing occurs quickly in order to minimize fluid loss. For instance, in some embodiments, the curing step takes place from about 1 second to about 30 minutes. In some embodiments, the curing step takes place from about 1 second to about 5 minutes. In some embodiments, the curing step takes place from about 1 second to about 30 seconds.

Formed Polymer Composites

The methods of the present disclosure can result in the formation of various types of polymer composites. Additional embodiments of the present disclosure pertain to the polymer composites.

In some embodiments, the polymer composites include a network of polymers and nanomaterials associated with the network of polymers. in some embodiments, the nanomaterials are dispersed within the network of polymers. In some embodiments, the nanomaterials are dissolved within the network of polymers. In some embodiments, the nanomaterials are dispersed and dissolved within the network of polymers.

In some embodiments, the polymer composite is associated with a geological formation. In some embodiments, the polymer composite is infiltrated into the geological formation. In some embodiments, the polymer composite is embedded with the geological formation.

The polymer composites of the present disclosure can be associated with a geological formation in various manners. For instance, in some embodiments, the polymer composite is attached onto the walls of a geological formation. In some embodiments, the polymer composite forms a layer on a surface of the geological formation. In some embodiments, the polymer composite fully infiltrates the geological formation. In some embodiments, the polymer composite partially infiltrates the geological formation. In some embodiments, the polymer composite partially infiltrates the geological formation and the surface of the geological formation to form a structure that resembles a filter cake.

In some embodiments, the polymer composite interfaces with the geological formation through various types of bonds and interactions. In some embodiments, the bonds and interactions include, without limitation, covalent bonds, non-covalent bonds, ionic bonds, hydrogen bonds, dipolar interactions, van der Waals interactions, and combinations thereof.

Effect of Polymer Composites on Geological Formations

The methods and polymer composites of the present disclosure provide numerous advantages. For instance, in some embodiments, the formed polymer composites of the present disclosure enhance the stability of a geological formation that contains the polymer composites. In some embodiments, the formed polymer composites of the present disclosure provide a mechanical reinforcement effect to the geological formation.

In some embodiments, the formed polymer composites of the present disclosure enhance the mechanical properties of a geological formation that contains the polymer composites (e.g., compressive strength, toughness, hardness, elastic modulus, and combinations thereof). For instance, in some embodiments, the formed polymer composites of the present disclosure enhance the compressive strength of a geological formation by more than about 100% (e.g., by about 200%). In some embodiments, the compressive strength of a geological formation that contains the polymer composites of the present disclosure ranges from about 5 Mpa to about 100 Mpa, from about 10 Mpa to about 100 Mpa, or from about 10 Mpa to about 15 Mpa.

In some embodiments, the formed polymer composites of the present disclosure enhance the toughness of a geological formation by more than about 100% (e.g., by about 600%). In some embodiments, the toughness of a geological formation that contains the polymer composites of the present disclosure ranges from about 5 J/m³ to about 100 J/m³, from about 10 J/m³ to about 100 J/m³, or from about 25 J/m³ to about 30 J/m³.

In some embodiments, the formed polymer composites of the present disclosure enhance the hardness of a geological formation by more than about 100% (e.g., by about 200%). In some embodiments, the hardness of a geological formation that contains the polymer composites of the present disclosure ranges from about 100 Mpa to about 5,000 Mpa, or from about 200 Mpa to about 1,000 Mpa. In some embodiments, the hardness of the geological formation is more than about 900 Mpa.

In some embodiments, the formed polymer composites of the present disclosure enhance the elastic modulus of a geological formation by more than about 100% (e.g., by about 500%). In some embodiments, the elastic modulus of a geological formation that contains the polymer composites of the present disclosure ranges from about 1 Gpa to about 1,000 Gpa, from about 5 Gpa to about 500 Gpa, or from about 10 Gpa to about 40 Gpa.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Microwave Heating of Functionalized Graphene Nanoribbons in Thermoset Polymers for Wellbore Reinforcement

In this Example, Applicants introduce a systematic strategy to prepare composite materials for wellbore reinforcement using graphene nanoribbons (GNRs) in a thermoset polymer irradiated by microwaves. Applicants show that microwave absorption by GNRs functionalized with polypropylene oxide (PPO-GNRs) cured the composite by reaching 200° C. under 30 W of microwave power. Nanoscale PPO-GNRs diffuse deep inside porous sandstone and dramatically enhance the mechanics of the entire structure via effective reinforcement. The bulk and the local mechanical properties measured by compression and nanoindentation mechanical tests, respectively, reveal that microwave heating of PPO-GNRs and direct polymeric curing are major reasons for this significant reinforcement effect.

In particular, this Example shows a proof of concept for wellbore strengthening by microwave heating functionalized GNRs dispersed in an oil based thermoset polymer to rapidly crosslink the matrix and thereby increase its mechanical resilience within sandstone. Polypropylene oxide (PPO) functionalization of the GNRs not only increased their dispersibility in the oil based drilling fluid, but also increased the amount of heat released by the GNRs under microwave irradiation, likely due to their optimal dispersion.

The temperature of the PPO-GNR polymer suspension dramatically increased above 200° C. within minutes under very low microwave power (30 W). The intense, localized heat from the PPO-GNRs cured the polymer within a short period of time producing both enhanced reinforcement and mechanical integrity of sandstone due to the improved load transfer characteristics from the microwave curing process.

The aforementioned method not only provides a facile and cost effective way to prepare polymer/carbon nanomaterial reinforced composites, but also may be useful in extreme downhole conditions provided that there is a microwave source tool following the drill head.

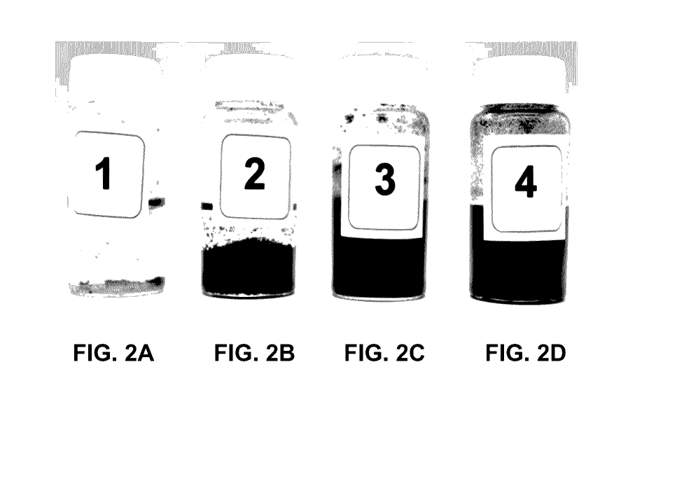

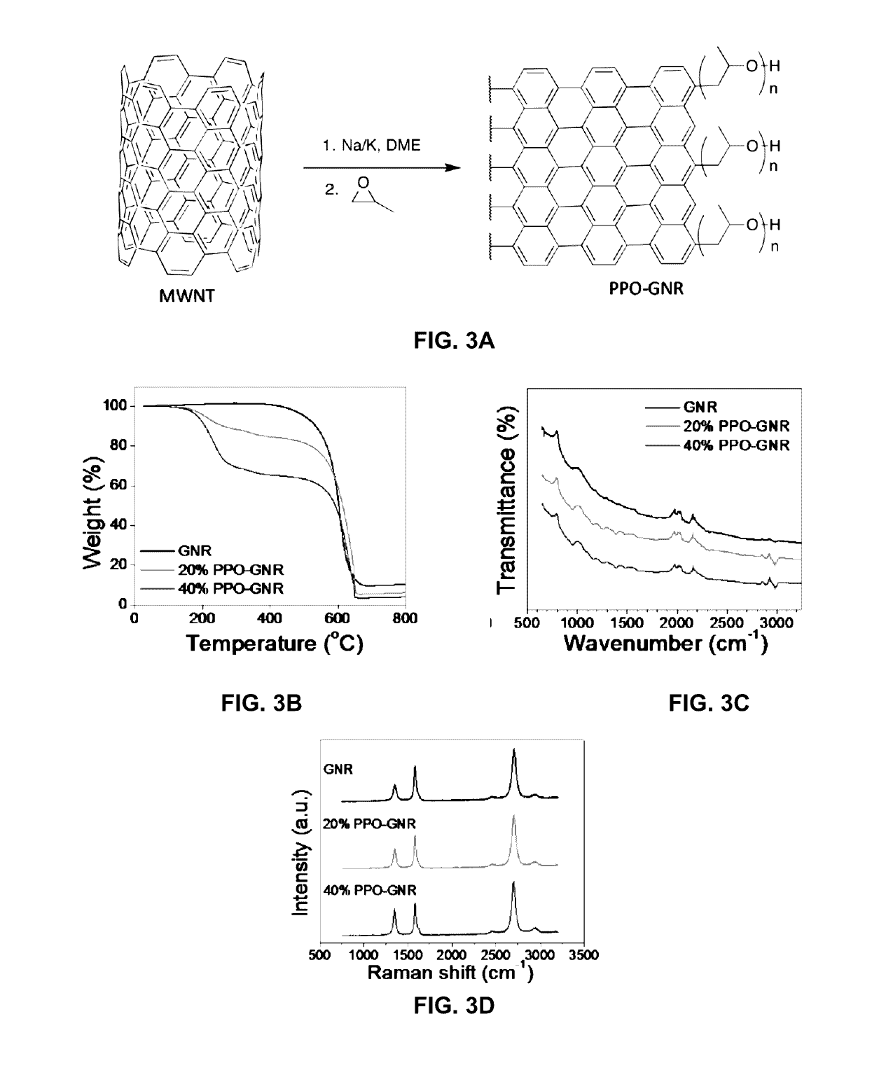

Applicants' first goal was to synthesize GNRs that were soluble in an organic phase and aqueous phase, since both types of drilling fluids are used in industry. As prepared, GNRs have protons at the edges and poor dispersibility (FIG. 2) in both water and Escaid™110 (a commercially available mineral oil based drilling fluid). However, GNRs functionalized with PPO emanating from their edges showed good dispersion in both water and Escaid™110 (FIG. 3A). Thermogravimetric analysis (TGA) showed gradual weight loss between 200-400° C. due to the decomposition of PPO (FIG. 3B), thus confirming that 20% (20%-PPO-GNR) and 40% (40%-PPO-GNR) of PPO was functionalized on the GNR surface depending on the synthesis method.

The presence of PPO was confirmed by Fourier transform infrared (FT-IR) analysis (FIG. 3C) with a characteristic peak at 2950 cm⁻¹ indicative of C—H stretches. Raman spectroscopy (FIG. 3D) showed that the D/G ratios increased with the amount of PPO functionalization due to the increased C-sp³ content.

Before making a polymeric composite with PPO-GNRs, a suitable thermoset polymer should be selected that is readily available for curing at moderate temperatures. In addition, there are several preferred criteria that must be considered when a thermoset polymer is selected for downhole applications. First, polymerization needs to be done very quickly before fluid loss occurs. Therefore, reactive species are preferred. Second, the polymer should preferably have a relatively high curing temperature to ensure that the high inherent temperature conditions (˜70° C.) in the wellbore do not prematurely result in crosslinking. Third, the polymer must preferably be inexpensive. Finally, the polymer must preferably have low toxicity.

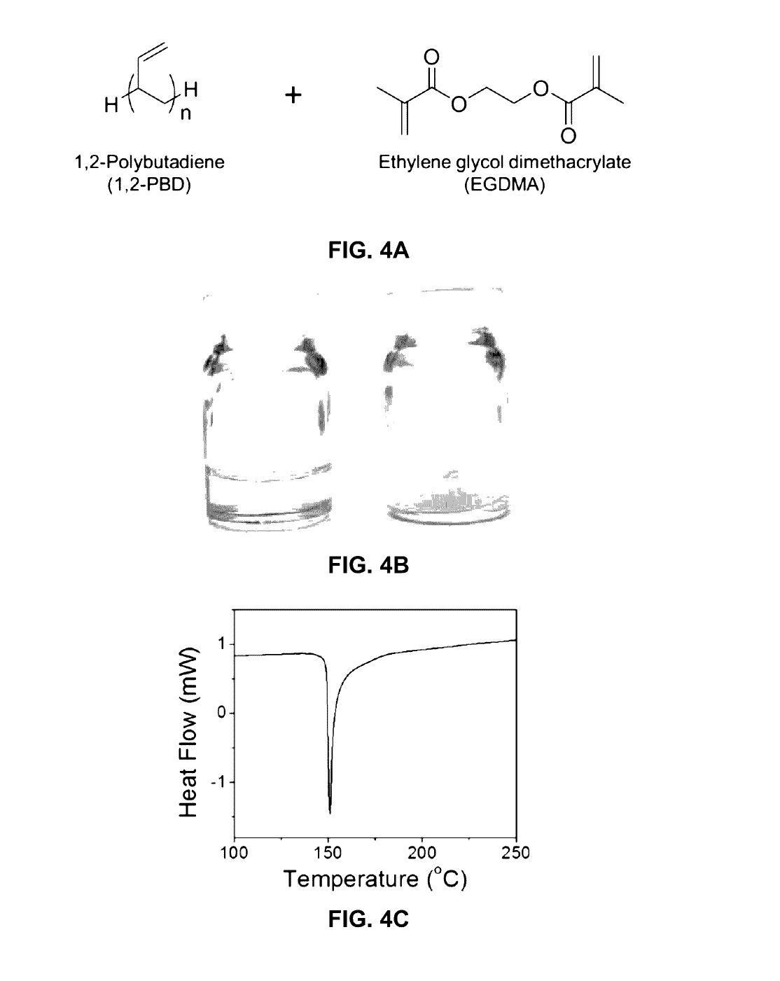

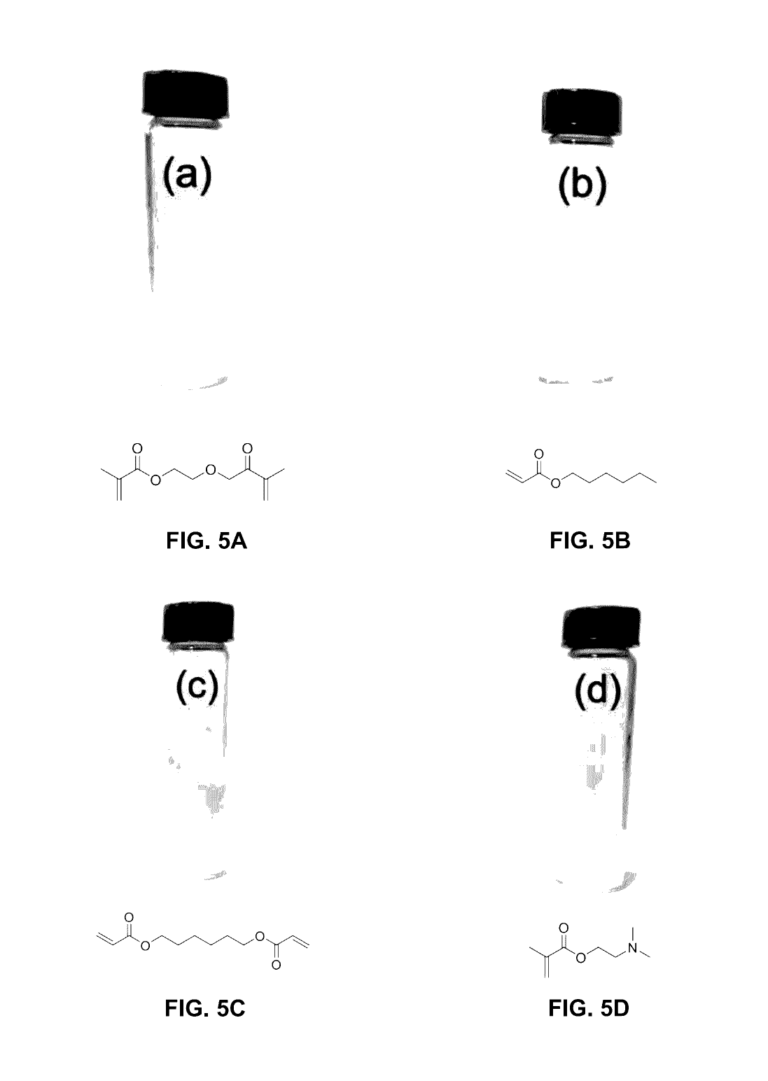

In view of the aforementioned selection criteria, Applicants chose 1,2-polybutadiene (1,2-PBD) and ethylene glycol dimethacrylate (EGDMA) as the polymer backbone and crosslinking monomer, respectively (FIGS. 4A and 5). A cross linking polymer stock solution (FIG. 4B) was prepared by mixing 1,2-PBD/EGDMA into Escaid™110, which could then be heat cured in a 200° C. oven, thereby producing a rigid white polymer block. Differential scanning calorimetry (DSC) showed a sharp exothermic characteristic at 150° C. arising from its phase transition during curing (FIG. 4C).

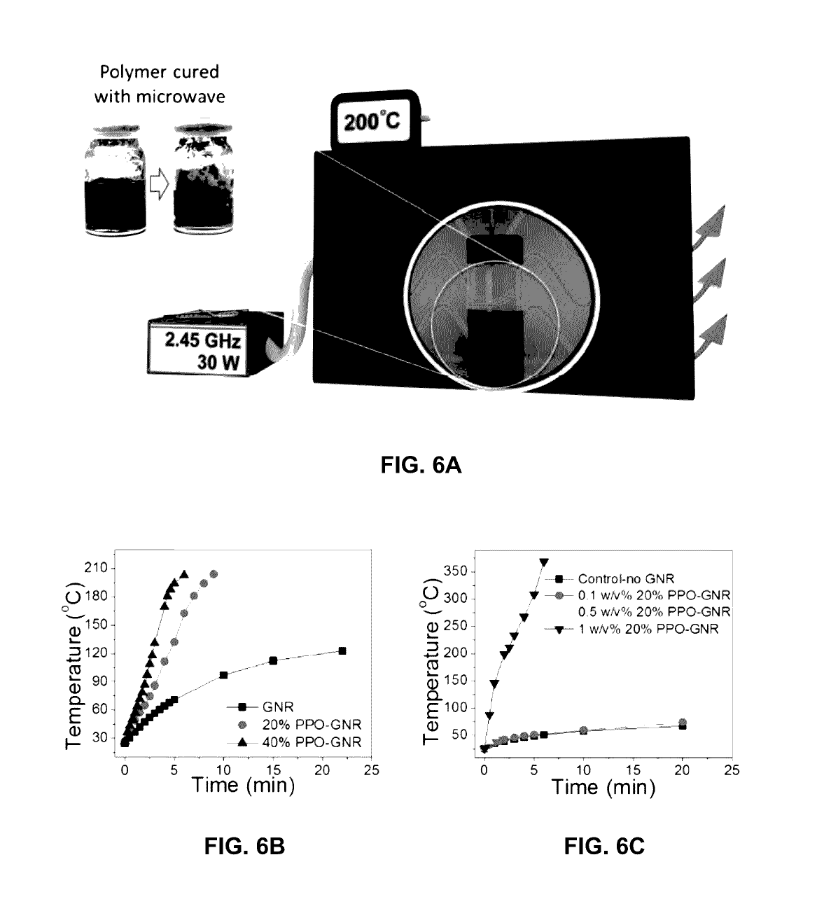

FIG. 6A illustrates the microwave waveguide and in situ temperature monitoring system used in Applicants' microwave assisted polymer curing experiments. FIG. 6B shows the heating profile of GNRs alone and PPO-GNRs with increasing amounts of PPO and a fixed amount of GNRs (0.5 w/v %) in the polymer stock solution. The polymer/GNR suspension slowly heated under microwave exposure but did not increase in temperature to more than 120° C.

However, PPO-GNRs show a much faster heating rate with an increase in temperature up to 200° C. within 10 minutes. 40%-PPO-GNR showed higher heating rates than 20%-PPO-GNR, presumably due to the higher dispersibility in the oil-based polymer solution. However, extremely rapid heating and very high temperatures of the polymer may not be optimal for curing because it may decompose the polymer or induce excessive outgassing from the composite, thereby making it a porous structure. Therefore, further experiments were conducted using different amounts of 20%-PPO-GNR to optimize the process.

The polymer stock solution itself did not display any significant microwave heating (FIG. 6C). Moreover, the addition of a small amount of PPO-GNR (0.1 w/v %) did not significantly affect the heating rate of the polymer composite (FIG. 6C). However, since 1 w/v % of PPO-GNR heated rapidly to very high temperatures that could damage the polymer backbone, 0.5 w/v % of the 20%-PPO-GNR stock solution was selected for further mechanical testing.

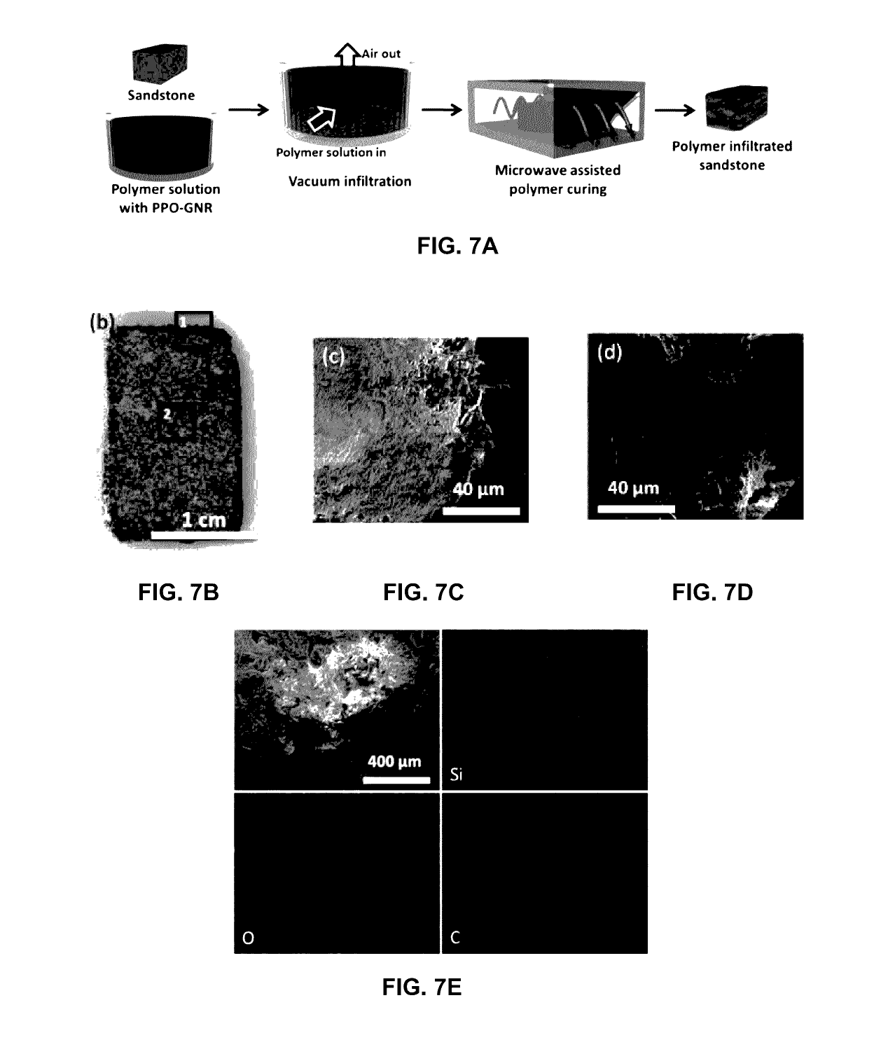

FIG. 7A schematically illustrates the process Applicants used to infiltrate a block of porous sandstone with polymer/PPO-GNRs for microwave curing (SPG-M is designated for microwave-cured polymer/PPO-GNR infiltrated sandstone). Vacuum infiltration was used to drive the polymer/PPO-GNRs into the porous sandstone as a mimic for the high pressure environment of a wellbore. A center cut section of the SPG-M showed numerous white spots that are not naturally present (FIG. 7B). Scanning electron microscopy (SEM) of SPG-M shows that the polymer and PPO-GNRs form thick film-like structures on the sandstone surface (FIG. 7C).

In the cross-section of the SPG-M, Applicants observed PPO-GNR strands attached onto the sandstone wall, which confirms successful infiltration of the stock polymer/PPO-GNR solution (FIG. 7D). Elemental mapping of the sandstone using energy dispersive X-rays (EDX) shows that the polymer and carbon nanomaterials were throughout the sandstone (FIG. 7E) as further confirmation that the sandstone and polymer composite structure had been successfully prepared.

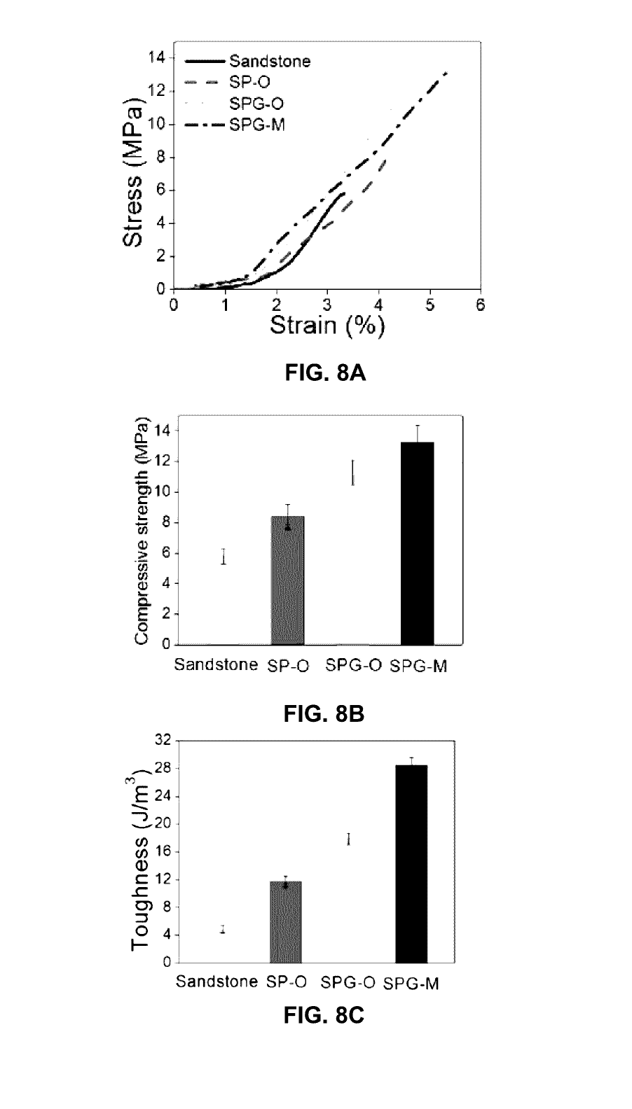

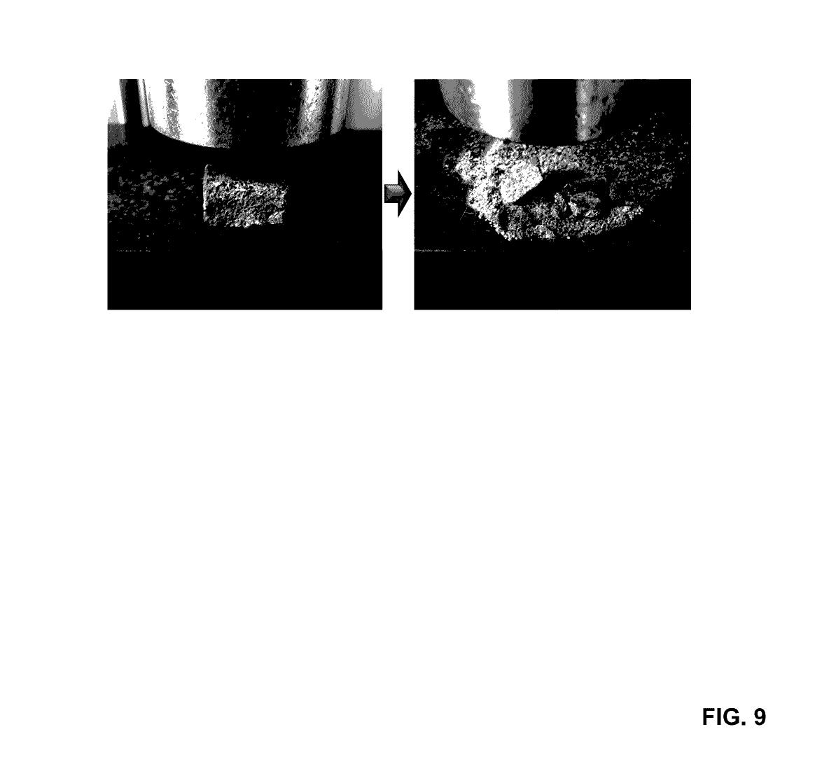

FIG. 8 shows the ensemble mechanical properties from the compression experiments on the polymer-infiltrated sandstone. The compression system using the parallel bottom and top platens to apply uniaxial force develops a rather complex system of stresses due to the end restraints by the platens. However, due to Poisson's effect, the samples all undergo lateral expansion which results in creating cracks and leading to failure of the samples (FIG. 9).

To compare the properties of SPG-M, several control samples were prepared using a convective oven to cure the materials. These control sandstone samples (denoted as SP-O and SPG-O) were cured in an oven without and with PPO-GNRs, respectively (O refers to oven-cured). By comparing these materials, the effect of either the addition of PPO-GNRs or microwave assisted polymer curing on the mechanical performance reinforcement was investigated.

Addition of polymer alone inside the sandstone increased the maximum compressive strength of the sandstone from 5.8 MPa to 8.4 MPa (FIGS. 8A-B). However, with the addition of PPO-GNRs, the maximum compressive strength of the SPG-M sample increased even higher to 11.3 MPa. Assuming equivalent porosities for oven cured sandstones infiltrated by polymer alone (SP-O) or polymer/PPO-GNRs (SPG-O), the 35% increase in the compressive strength of SPG-O compared to SP-O is likely due to: 1) the reinforcing effect of GNRs, which strengthen its surrounding matrix; and 2) the high thermal conductivity of the GNRs, which causes more adequate and rapid curing of the polymer in SPG-O compared to SP-O, resulting in a more efficient high-strength adhesive bonding between polymer and sandstone.

More enhancement in reinforcement can be found in SPG-M, where the maximum compressive strength of SPG-M (13.3 MPa) increased more than 130% compared to that of pure sandstone. Moreover, the compressive strength of SPG-M is about 18% higher than that of SPG-O the oven cured equivalent.

Without being bound by theory, such a strong reinforcement in SPG-M can be understood by comparing microwave assisted heating to convective heating of the polymer in SPG-O. In the oven-heated thermoset polymer, GNRs are one part of a physical mixture inside the composite. Due to the low thermal diffusion through the sandstone and the non-uniformly distributed pores filled by polymer, heat cannot be homogeneously transferred to the GNRs dispersed in the polymer. However, with microwaves, each GNR absorbs microwave energy independently and acts as a nanoscale heat generator with local temperatures that are high enough to thoroughly cure the surrounding polymer.

Moreover, since the GNRs generate heat to induce polymerization, it can be assumed that the interface between the GNR and polymer has greater van der Waals interactions and will provide a more effective load transfer for stronger reinforcement than SPG-O. Another potential reinforcement mechanism could be that the polymer's radical chains were added into the planes of the GNRs.

Furthermore, the total toughness of the SPG-M (28.5 GPa) was about 1.6 times higher than that of SPG-O, and also about 6 times greater than that of pure sandstone (4.9 GPa) (FIG. 8C). Toughness is defined as the amount of energy a material absorbs before failure (representing the work-of-fracture), which is different from the classical “fracture toughness” with the unit of Pₐ\sqrt{m}. The work-of-fracture is the area under the stress—strain curve, which is affected by gradual fracture (i.e., “graceful fracture”), whereas the fracture toughness does not incorporate this entire process.

To investigate the micromechanics of the samples and to study the microstructural reinforcement effects of GNRs, a matrix-based algorithm was developed to conduct hundreds of indentations on the surface of the samples in order to directly obtain the mechanics of individual phases of the samples. The nanoindentation measurements were conducted by indenting 100 spots in a 10×10 matrix form using a Berkovich tip with a size of ˜50 nm, which allowed Applicants to investigate the mechanical properties (FIG. 9) of the composite structure on both the nanometer and micrometer scales.

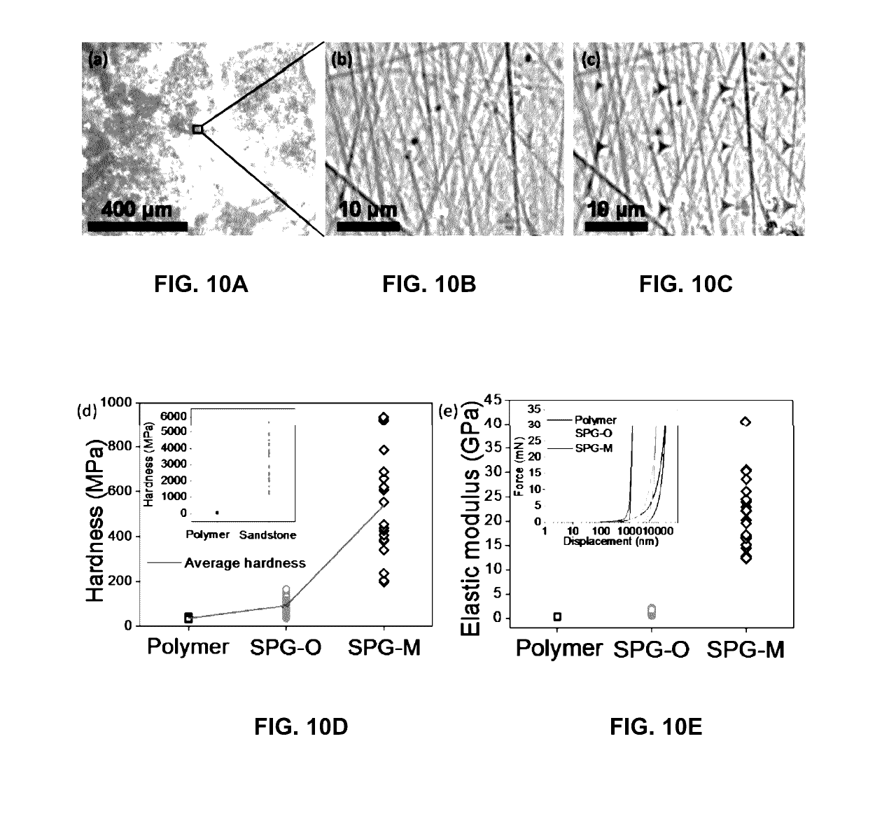

FIGS. 10A-B show the surface of the SPG-M sample before indentation. Some imprints (triangles) of the indentation on the sample surface can be seen in FIG. 10C after unloading.

From the control experiments for the polymer and sandstone, the hardness value (which relates to strength) was found to be 30 MPa for the polymer alone, and over 1000 MPa for the sandstone alone (FIG. 10D inset). Therefore, to compare the mechanical reinforcement contribution of the polymer, hardness values larger than 1000 MPa were excluded from further analysis as they would correspond to the sandstone alone and not the cured polymer/PPO-GNRs. As GNRs were introduced to the polymer in the SPG-O, the hardness of the polymer was increased up to 180 MPa. However, for SPG-M, hardness values were more than 200 MPa with values ranging from 200 to 900 MPa (FIG. 10D).

The aforementioned variation may be due to the localized grid-like indented spots, which may or may not be in the vicinity of the GNRs. Nevertheless, the average hardness (˜600 MPa) of all these spots in SPG-M is significantly higher than the average hardness of SPG-O (˜100 MPa). Considering the measurement capabilities of nanoindentation (50 nm tip size and ˜10 μm distance between the indentation spots), Applicants' results show that the enhanced mechanical properties of SPG-M are mainly due to the strong interactions between GNRs and the polymer, which improves the cross-linking and mechanical integrity of the polymer upon microwave irradiation.

The elastic modulus of the samples was also calculated using the load-displacement curves (inset of FIG. 10E). All P-h curves in this figure showed smooth shapes. Moreover, no pop-in behavior could be detected. The lower displacement of the SPG-M at the peak force indicates the higher hardness of this sample, compared to SPG-O/SP-O, resulting in lower material deformation. SPG-M also showed a highly enhanced elastic modulus compared to SPG-O, owing to the incorporation of stiff GNR fillers into the polymer chains resulting in a stiffer composite material (FIG. 10E). These results demonstrate that microwave assisted polymer curing in the presence of carbon nanomaterials can be a highly efficient method for structural reinforcement.

In summary, Applicants have demonstrated in this Example that the use of GNRs as highly efficient fillers in polymers, combined with microwave-assisted localized heating, results in the significantly improved mechanical properties of polymer reinforced sandstone. Systematic investigation of the mechanical properties (e.g. strength, toughness, and stiffness) of the polymer-reinforced sandstone at multiple length scales suggests that the interaction of carbon nanomaterials with a polymer matrix provides enhanced reinforcement, even with a very low amount of carbon filler. Finally, while Applicants showcased the benefits of this approach in the context of enhancing the mechanics of porous sandstones and wellbore reinforcements, the concepts and strategies of this work, especially the use of low power microwave energy, can be easily applicable to a variety of porous materials and extreme conditions such as those found underground.

### EXAMPLE 1.1

### Synthesis of PPO-GNRs

GNRs were prepared by Na/K-induced longitudinal splitting of multi-walled carbon nanotubes (MWNTs). See ACS Nano, 2012, 6, 4231-4240. Applicants adapted this method for the synthesis of polypropylene-oxide functionalized GNRs (PPO-GNRs). First, MWNTs (500 mg) were placed in a dried and septum-sealed flask, purged with nitrogen followed by the addition of 250 mL of freshly distilled dimethyl ether. Next, the mixture was bath sonicated for 30 minutes. Thereafter, Na/K alloy (0.80 mL) was carefully injected into the reaction flask via syringe and the mixture was stirred at room temperature for 72 hours. Propylene oxide (1 mL) was then injected into the reaction flask, and the mixture was stirred at room temperature for 24 hours before it was quenched by addition of methanol (5 mL). The resulting PPO-GNRs were isolated via vacuum filtration over a 0.45 μm PTFE filter and washed sequentially with deionized water, methanol, acetone, and diethyl ether. The product was dried under vacuum at 60° C. for 24 hours to produce about 750 mg of 20%-PPO containing GNRs (20%-PPO-GNR). For the synthesis of 40%-PPO-GNR, Applicants doubled the amount of propylene oxide (2 mL), while the amount of other reagents remained the same, which produced about 1000 mg of 40%-PPO-GNR. Synthesized materials were characterized by thermogravimetric analysis (Q50, TA instruments), FT-IR spectroscopy (Nicolet Nexus 870, Thermo Fisher Scientific), and Raman spectroscopy (inVia micro Raman, Renishaw).

### EXAMPLE 1.2

### Preparation of Polymer/PPO-GNR Stock Solution

1,2-PBD (Sigma-Aldrich, CAS no:9003-17-2) was selected as a polymer backbone and EGDMA (Sigma-Aldrich, CAS no:97-90-5) as a cross-linking agent. A polymer stock solution was prepared by first mixing 2 g of 1,2-PBD with 64 mL of EGDMA (which corresponds to a 1:10 molar ratio of butadiene repeating groups and EGDMA), then mixing the polymer solution with Escaid™110 in a 1:1 volume ratio. This ratio of very high crosslinking component was selected because of the high rate of crosslinking that will be needed in the downhole drilling environment. To prepare a polymer/PPO-GNR suspension, PPO-GNRs were added to the polymer stock solution (1,2-PBD/EGDMA/Escaid™110) in different w/v % (note, 10 mg/mL=1 w/v %). As a control, Applicants also prepared a polymer/GNR suspension using the same polymer stock solution mixed with GNRs alone.

### EXAMPLE 1.3

### Microwave Heating and Curing of Polymer/PPO-GNRs

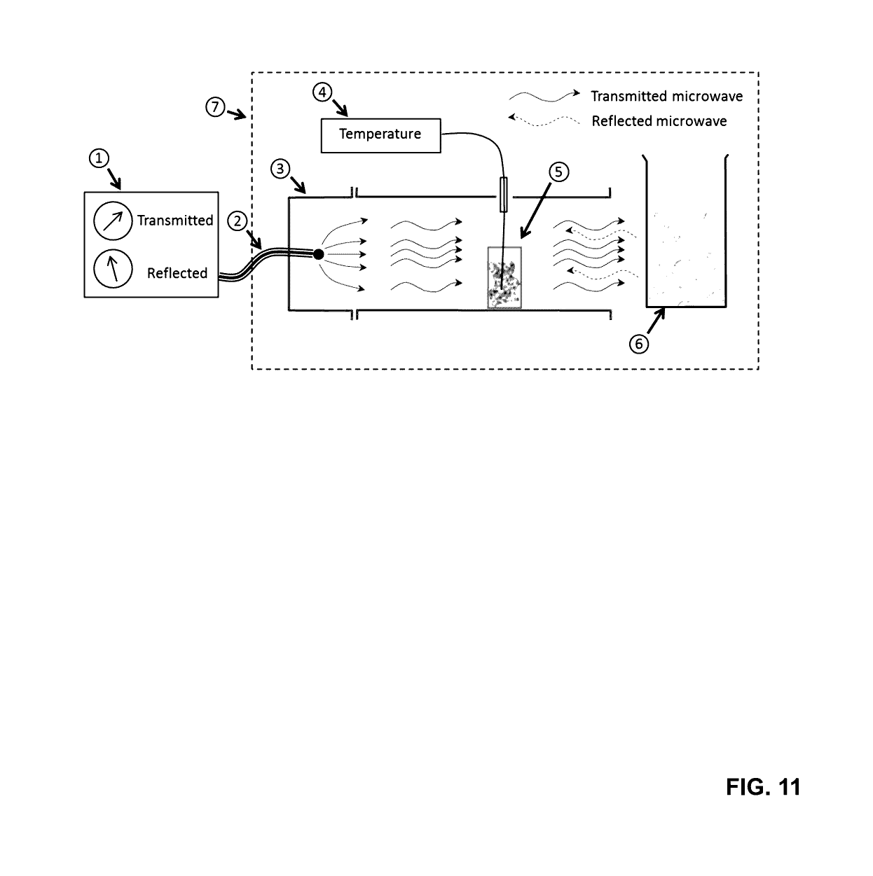

Applicants' experimental system consisted of a variable power (10-70 W) 2.45 GHz microwave generator, a thermocouple for in situ temperature monitoring, and waveguide which directs the microwaves onto the sample (FIG. 11). The waveguide provides well-defined field intensity within its central region to uniformly irradiate the sample. The polymer/PPO-GNRs suspension was placed inside a waveguide under 30 W of microwave irradiation and after the temperature reached about 200° C. The entire suspension was cured, which formed a dark gray composite. Any possible microwave absorbing properties of the thermocouple was taken into account by measuring the temperature increase recorded (40-50° C.) when the thermocouple alone was exposed to microwave radiation.

### EXAMPLE 1.4

### Microwave Heating and Curing of Polymer/PPO-GNRs Solution in Sandstone

A porous sandstone block (19 mm×19 mm×12.7 mm; Dundee, Cleveland Quarries, ˜9 g) was immersed into a polymer/PPO-GNR suspension in a 20 mL glass container and placed under vacuum (−100 kPa) to drive the suspension into the sandstone. The polymer/PPO-GNR suspension-infiltrated sandstone was then placed within the middle of the waveguide and exposed to 30 W of microwave irradiation. The SPG-M sample reached a temperature of 200° C. within about 3 minutes and held at that temperature for another 10 minutes with the continued irradiation. The microwave source was then turned off, and the sandstone composite was permitted to cool. As a control, Applicants also prepared SP-O and SPG-O, which were cured in an oven without and with PPO-GNRs, respectively.

### EXAMPLE 1.5

### Mechanical Strength Testing of Polymer/PPO-GNRs Infiltrated Sandstone

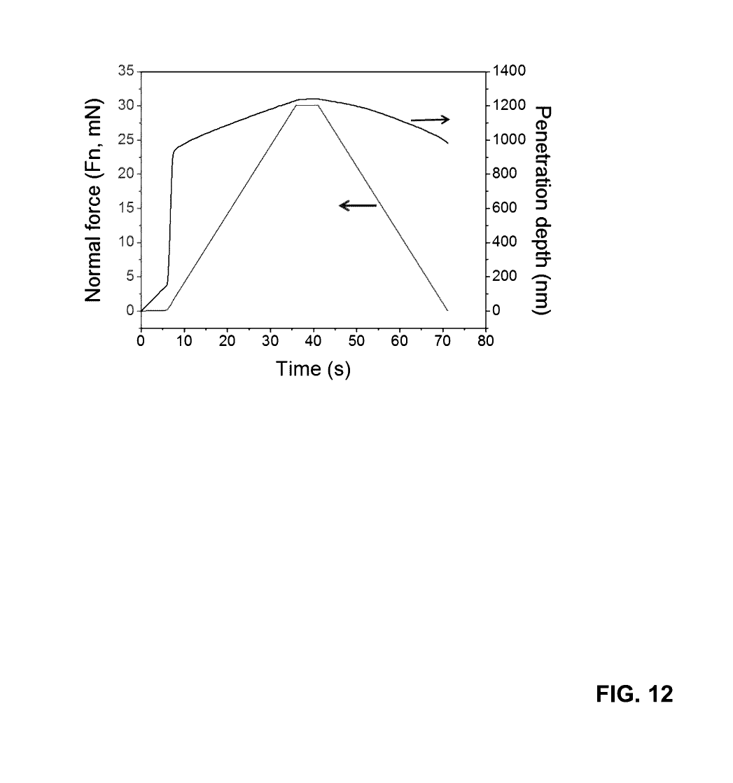

A conventional static compression test was carried out on the SPG-M using an Instron Dual Column Universal Testing System (Model 4500) with a 100 kN load cell to measure the bulk mechanical properties. Uniaxial compression loading was applied until the failure cracks, approximately parallel to the direction of the applied load, appeared on the side of the samples and then the sample crushed. An Anton-Paar nanoindentation tester (NHT²) equipped with the diamond Berkovich tip was used to collect local surface mechanical characterization data by indenting to depths at the nano- and micrometer scales. A grid technique was used for the indentation tests (100 points in the shape of a 10×10 matrix where each point is 10 μm apart). Before testing, the surfaces of the samples were ground with sandpaper (hand ground using sandpaper grade from 200 to 2000) and cleaned with a soft cloth to provide a smooth surface relevant for indentation testing. The nanoindentation was set to the force-controlled mode to apply a maximum force of 30 mN in each indent. A trapezoidal loading-unloading cycle was used, which consists of the 3 stages (i.e., loading to maximum force, holding for 5 seconds at the peak load, and unloading) (FIG. 12).

Next, from the load-displacement of nanoindentation P-h curves, Applicants obtained the elastic modulus (E), and hardness (H) using by Equation 1.

$$E = \frac{\frac{0.5 π S}{\sqrt{a}}}{1 - {v}^{2}} , H = \frac{{P}_{max}}{a} \qquad ( 1 )$$

In Equation 1, a is the contact area at Pₘₐₓ, S is the slope of the unloading curve, and v is Poisson's ratio.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of forming a polymer composite, said method comprising:
exposing a solution to a microwave source, wherein the solution comprises:
a nanomaterial, and
a cross-linkable polymer component; and
wherein the exposing results in the curing of the cross-linkable polymer component in the presence of the nanomaterial to form the polymer composite.

2. The method of claim 1, wherein the solution comprises an additive selected from the group consisting of viscosifiers, surfactants, clays, weighting agents, and combinations thereof.

3. The method of claim 1, wherein the solution comprises a base fluid selected from the group consisting of oleaginous fluids, non-oleaginous fluids, and combinations thereof.

4. The method of claim 3, wherein the base fluid comprises an oleaginous fluid selected from the group consisting of natural oils, synthetic oils, diesel oils, mineral oils, invert emulsions thereof, and combinations thereof.

5. The method of claim 3, wherein the base fluid comprises a non-oleaginous fluid selected from the group consisting of water, sea water, brine, and combinations thereof.

6. The method of claim 1, wherein the solution comprises a cross-linking agent.

7. The method of claim 6, wherein the cross-linking agent is selected from the group consisting of free radical initiators, sulfur-based cross-linking agents, isocyanate-based cross-linking agents, isocyanurate-based cross-linking agents, maleimide-based cross-linking agents, ester-based cross-linking agents, carbodiimide-based cross-linking agents, azide-based cross-linking agents, and combinations thereof.

8. The method of claim 1, wherein the nanomaterial comprises an amphiphilic nanomaterial.

9. The method of claim 1, wherein the nanomaterial is selected from the group consisting of carbon nanomaterials, graphite, single-walled carbon nanotubes, multi-walled carbon nanotubes, ultra-short carbon nanotubes, graphene, graphene oxide, graphene nanoribbons, carbon black, glassy carbon, carbon nanofoam, silicon carbide, buckminsterfullerene, buckypaper, nanofiber, nanoplatelets, nano-onions, nanoribbons, nanohorns, nano-hybrids, carbon fibers, metal nanoparticles, iron nanoparticles, derivatives thereof, and combinations thereof.

10. The method of claim 1, wherein the nanomaterial comprises graphene nanoribbons.

11. The method of claim 10, wherein the graphene nanoribbons are selected from the group consisting of functionalized graphene nanoribbons, pristine graphene nanoribbons, doped graphene nanoribbons, mixtures of graphene nanoribbons and carbon nanotubes, graphene oxide nanoribbons, reduced graphene oxide nanoribbons, and combinations thereof.

12. The method of claim 1 wherein the nanomaterial is functionalized with one or more functional groups.

13. The method of claim 12, wherein the functional groups are selected from the group consisting of alkyl groups, alkyl halides, hydroxyl alkyl groups, amino alkyl groups, haloalkyl groups, alkenyl groups, alkynyl groups, sulfate groups, sulfonate groups, carboxyl groups, benzenesulfonate groups, amines, alkyl amines, nitriles, quaternary amines, thermoplastic polymers, and combinations thereof.

14. The method of claim 1, wherein the nanomaterial comprises functionalized graphene nanoribbons.

15. The method of claim 1, wherein the nanomaterial comprises from about 0.1 wt % to about 50 wt % of the solution.

16. The method of claim 1, wherein the cross-linkable polymer component is selected from the group consisting of polymers, monomers, and combinations thereof.

17. The method of claim 1, wherein the cross-linkable polymer component comprises polymers.

18. The method of claim 17, wherein the polymers are selected from the group consisting of thermoset polymers, thermoplastic polymers, and combinations thereof.

19. The method of claim 1, wherein the cross-linkable polymer component comprises thermoplastic polymers selected from the group consisting of polylactic acid, polybenzimidazole, polycarbonate, polyether sulfone, poly ether ether ketone, polyetherimide, polyethylene, polyphenylene oxide, polyphenylene sulfide, polypropylene, polystyrene, polyvinyl chloride, poly(methyl methacrylate), acrylonitrile butadiene styrene, nylon, polylactic acid, teflon, and combinations thereof.

20. The method of claim 1, wherein the cross-linkable polymer component comprises monomers.

21. The method of claim 20, wherein the monomers are selected from the group consisting of epoxy resins, olefin monomers, amines, etheramines, alcohols, styrenes, butadienes, isocyanates, lactic acids, benzimidazoles, carbonates, ether sulfones, ether ketones, etherimides, ethylenes, phenylene oxides, phenylene sulfides, propylenes, styrenes, vinyl chlorides, methacrylates, acrylonitriles, and combinations thereof.

22. The method of claim 1, wherein the curing comprises microwave-triggered activation of the crosslinkable polymer component.

23. The method of claim 1, wherein the microwave source heats the nanomaterials, and wherein the heat from the nanomaterials induces the polymerization of the cross-linkable polymer components in the solution.

24. The method of claim 1, wherein the formed polymer composite comprises a network of polymers, wherein the nanomaterial is dispersed within the network of polymers.

25. The method of claim 1, wherein the exposing occurs in a geological formation.

26. The method of claim 25, further comprising a step of introducing the solution into the geological formation.

27. The method of claim 25, wherein the geological formation is selected from the group consisting of subterranean formations, wellbores, boreholes, sandstones, shale formations, carbonates, mudstones, oil fields, and combinations thereof.

28. The method of claim 25, wherein the formed polymer composite becomes embedded with the geological formation.

29. The method of claim 25, wherein the polymer composite forms a layer on a surface of the geological formation.

30. The method of claim 25, wherein the formed polymer composite enhances the stability of the geological formation.

31. The method of claim 25, wherein the formed polymer composite enhances the mechanical properties of the geological formation, wherein the enhanced mechanical properties are selected from the group consisting of compressive strength, toughness, hardness, elastic modulus, and combinations thereof.

32. The method of claim 1, wherein the solution is exposed to the microwave source through a waveguide.

33. The method of claim 1, wherein the microwave source comprises a radiofrequency (RF) source.

34. A polymer composite comprising:
a network of polymers; and
a nanomaterial associated with the network of polymers.

35. The polymer composite of claim 34, wherein the polymer composite further comprises an additive selected from the group consisting of viscosifiers, surfactants, clays, weighting agents, and combinations thereof.

36. The polymer composite of claim 34, wherein the polymer composite further comprises a base fluid selected from the group consisting of natural oils, synthetic oils, diesel oils, mineral oils, water-in-oil emulsions, water, sea water, brine, and combinations thereof.

37. The polymer composite of claim 34, wherein the nanomaterial is selected from the group consisting of carbon nanomaterials, graphite, single-walled carbon nanotubes, multi-walled carbon nanotubes, ultra-short carbon nanotubes, graphene, graphene oxide, graphene nanoribbons, carbon black, glassy carbon, carbon nanofoam, silicon carbide, buckminsterfullerene, buckypaper, nanofiber, nanoplatelets, nano-onions, nanoribbons, nanohorns, nano-hybrids, carbon fibers, metal nanoparticles, iron nanoparticles, derivatives thereof, and combinations thereof.

38. The polymer composite of claim 34, wherein the nanomaterial comprises graphene nanoribbons.

39. The polymer composite of claim 38, wherein the graphene nanoribbons are selected from the group consisting of functionalized graphene nanoribbons, pristine graphene nanoribbons, doped graphene nanoribbons, mixtures of graphene nanoribbons and carbon nanotubes, graphene oxide nanoribbons, reduced graphene oxide nanoribbons, and combinations thereof.

40. The polymer composite of claim 34, wherein the nanomaterial is functionalized with one or more functional groups.

41. The polymer composite of claim 40, wherein the functional groups are selected from the group consisting of alkyl groups, alkyl halides, hydroxyl alkyl groups, amino alkyl groups, haloalkyl groups, alkenyl groups, alkynyl groups, sulfate groups, sulfonate groups, carboxyl groups, benzenesulfonate groups, amines, alkyl amines, nitriles, quaternary amines, thermoplastic polymers, and combinations thereof.

42. The polymer composite of claim 34, wherein the nanomaterial comprises functionalized graphene nanoribbons.

43. The polymer composite of claim 34, wherein the nanomaterial comprises from about 0.1 wt % to about 50 wt % of the polymer composite.

44. The polymer composite of claim 34, wherein the network of polymers comprises polymers selected from the group consisting of thermoset polymers, thermoplastic polymers, and combinations thereof.

45. The polymer composite of claim 34, wherein the network of polymers comprises thermoplastic polymers selected from the group consisting of polylactic acid, polybenzimidazole, polycarbonate, polyether sulfone, poly ether ether ketone, polyetherimide, polyethylene, polyphenylene oxide, polyphenylene sulfide, polypropylene, polystyrene, polyvinyl chloride, poly(methyl methacrylate), acrylonitrile butadiene styrene, nylon, polylactic acid, teflon, and combinations thereof.

46. The polymer composite of claim 34, wherein the nanomaterial is dispersed within the network of polymers.

47. The polymer composite of claim 34, wherein the polymer composite is associated with a geological formation.

48. The polymer composite of claim 47, wherein the geological formation is selected from the group consisting of subterranean formations, wellbores, boreholes, sandstones, shale formations, carbonates, mudstones, oil fields, and combinations thereof.

49. The polymer composite of claim 47, wherein the polymer composite is embedded with the geological formation.

50. The polymer composite of claim 47, wherein the polymer composite forms a layer on a surface of the geological formation.

51. A method comprising:
introducing into a geological formation a fluid comprising a base fluid and graphene nanoribbons, wherein the graphene nanoribbons are selected from the group consisting of functionalized graphene nanoribbons, pristine graphene nanoribbons, doped graphene nanoribbons, mixtures of graphene nanoribbons and carbon nanotubes, graphene oxide nanoribbons, reduced graphene oxide nanoribbons, and combinations thereof; and
irradiating the geological formation with microwaves.

52. The method of claim 51, wherein the graphene nanoribbons are functionalized with one or more functional groups.

53. The method of claim 52, wherein the functional groups are selected from the group consisting of alkyl groups, alkyl halides, hydroxyl alkyl groups, amino alkyl groups, haloalkyl groups, alkenyl groups, alkynyl groups, sulfate groups, sulfonate groups, carboxyl groups, benzenesulfonate groups, amines, alkyl amines, nitriles, quaternary amines, thermoplastic polymers, and combinations thereof.

54. The method of claim 51, wherein the graphene nanoribbons are dispersed within a network of polymers, wherein the network of polymers are in the form a polymer composite.

55. The method of claim 54, wherein the graphene nanoribbons comprise from about 0.1 wt % to about 50 wt % of the polymer composite.

56. The method of claim 54, wherein the network of polymers comprises polymers selected from the group consisting of thermoset polymers, thermoplastic polymers, and combinations thereof.

57. The method of claim 54, wherein the network of polymers comprises thermoplastic polymers selected from the group consisting of polylactic acid, polybenzimidazole, polycarbonate, polyether sulfone, poly ether ether ketone, polyetherimide, polyethylene, polyphenylene oxide, polyphenylene sulfide, polypropylene, polystyrene, polyvinyl chloride, poly(methyl methacrylate), acrylonitrile butadiene styrene, nylon, polylactic acid, teflon, and combinations thereof.

58. The method of claim 54, wherein the polymer composite is associated with a geological formation.

59. The method of claim 54, wherein the polymer composite is embedded with the geological formation.

60. The method of claim 54, wherein the polymer composite forms a layer on a surface of the geological formation.

61. The method of claim 51, wherein the geological formation is selected from the group consisting of subterranean formations, wellbores, boreholes, sandstones, shale formations, carbonates, mudstones, oil fields, and combinations thereof.
